(19) United States
(12) Patent Application Publication
(10) Pub. No.: US 2026/0321289 A1
(43) Pub. Date: Oct. 15, 2026

(54) VIDEO SIGNAL PROCESSING DEVICE, VIDEO SIGNAL PROCESSING METHOD, AND RECORDING MEDIUM

(71) Applicant: Panasonic Intellectual Property Management Co., Ltd., Osaka (JP)

(72) Inventor: Gembu ITO, Osaka (JP)

(21) Appl. No.: 19/482,281

(22) PCT Filed: Apr. 11, 2024
(86) PCT No.: PCT/JP2024/014750

§ 371 Date: Nov. 7, 2025

(30) Foreign Application Priority Data
Sep. 5, 2023 (JP) 2023-143791

(51) Int. Cl. G11B 27/00; G09G 5/14

(52) U.S. Cl. CPC G11B 27/005; G09G 5/14; G09G 2340/10

(57) ABSTRACT

A processing device includes: a receiving interface that receives a video signal that represents a moving image; a video processing circuit that generates a first signal by performing video processing in a pattern on the video signal; a capture circuit that generates a second signal by capturing the video signal received by the receiving interface a compositing circuit that outputs a composite signal by compositing the first signal and the second signal; and a processor that: (a) in a first period, controls the compositing circuit to output the first signal as the composite signal; (b) in a second period, controls the video processing circuit to perform changing of the pattern of the video processing performed by the video processing circuit; and (c) in a change period, controls: the capture circuit to generate the second signal; and the compositing circuit to output the second signal as the composite signal.

### TECHNICAL FIELD

The present disclosure relates to a video signal processing device, a video signal processing method, and a program.

### BACKGROUND ART

A video signal processing device that displays video by performing video processing on a video signal including a moving image has been conventionally known. A technique for controlling a video signal processing device to read out a video signal written in a memory immediately before switching a video signal has been conventionally known (for example, see Patent Literature (PTL) 1).

### CITATION LIST

### Patent Literature

[PTL 1] Japanese Unexamined Patent Application Publication No. H03-242095

### SUMMARY OF INVENTION

### Technical Problem

When a video signal processing device switches video processing performed on a video signal, there is a possibility of muting the video signal. In this case, there is a problem that the video signal may be muted at a timing that is not intended by a user.

The present disclosure provides a video signal processing device, a video signal processing method, and a program that suppress muting of a video signal in a period of switching video processing.

### Solution to Problem

A video signal processing device according to the present disclosure includes: a receiving interface that receives a video signal that represents a moving image; a video processing circuit that generates a first signal by performing video processing in a pattern among a plurality of video processing patterns in which the video processing circuit is capable of performing video processing on the video signal received by the receiving interface; a capture circuit that generates a second signal by capturing the video signal received by the receiving interface; a compositing circuit that outputs a composite signal by compositing the first signal and the second signal; and a processor that: (a) in a first period, controls the compositing circuit to output the first signal as the composite signal; (b) in a second period, controls the video processing circuit to perform changing of the pattern of the video processing performed by the video processing circuit, the second period being a period not included in the first period; and (c) in a change period, controls: the capture circuit to generate the second signal; and the compositing circuit to output the second signal as the composite signal, the change period being a period in which the changing is performed.

### Advantageous Effects of Invention

A video signal processing device according to the present disclosure can suppress muting of a video signal in a period of switching video processing.

### BRIEF DESCRIPTION OF DRAWINGS

FIG. 1 is an explanatory diagram illustrating a configuration of a system according to an embodiment and a configuration of a display device including a processing device.

FIG. 2 is an explanatory diagram illustrating a pattern table that indicates a plurality of video processing patterns according to the embodiment.

FIG. 3 is an explanatory diagram illustrating a time table that indicates a time length required for changing a setting of video processing according to the embodiment.

FIG. 4 is a first explanatory diagram illustrating composite processing performed by an adder circuit according to the embodiment.

FIG. 5 is a second explanatory diagram illustrating composite processing performed by the adder circuit according to the embodiment.

FIG. 6 is a third explanatory diagram illustrating composite processing performed by the adder circuit according to the embodiment.

FIG. 7 is a flowchart showing processing performed by a processor when changing video processing according to the embodiment.

FIG. 8 is an explanatory diagram illustrating an example of processing performed by the processing device according to the embodiment.

FIG. 9 is a flowchart showing processing performed by a processor when changing video processing according to Variation 2 of the embodiment.

FIG. 10 is an explanatory diagram illustrating an example of processing performed by a processing device according to Variation 2 of the embodiment.

### DESCRIPTION OF EMBODIMENTS

### Underlying Knowledge Forming Basis of the Present Disclosure

Regarding the video signal processing device described in [Background Art], the inventor has found a problem described below.

A technique for changing, based on a signal received from a transmitter, video processing performed on a video signal by a video signal processing device has been conventionally known. For example, in the high-definition multimedia interface (HDMI) (registered trademark) 2.1 standard, video processing performed on a video signal by a video signal processing device can be changed by the auto low latency mode (ALLM) function, based on a signal received from a transmitter.

When video processing performed on a video signal is switched, the video signal outputted by the video signal processing device may include noise. In order to suppress display of the video signal including noise, the video signal processing device may mute the video signal in a period of switching video processing. When the video signal processing device changes video processing in response to receiving, from a transmitter, a signal that gives an instruction to change video processing, there is a possibility that a timing of changing video processing is not based on an instruction from a user and, as a result, there is a possibility that the user feels discomfort because of muting of the video signal at a timing that is not intended by the user.

If the video signal is muted at a timing that is not intended by the user, this muting may be recognized as reduction of the quality of the video signal provided to the user or as a malfunction of the video signal processing device.

The present disclosure provides a video signal processing device, a video signal processing method, and a program that suppress muting of a video signal in a period of switching video processing.

Hereinafter, examples of the invention obtained from the content disclosed in the present Specification will be provided and the effect or the like obtained from the invention will be described.

(1) A video signal processing device includes: a receiving interface that receives a video signal that represents a moving image; a video processing circuit that generates a first signal by performing video processing in a pattern among a plurality of video processing patterns in which the video processing circuit is capable of performing video processing on the video signal received by the receiving interface; a capture circuit that generates a second signal by capturing the video signal received by the receiving interface; a compositing circuit that outputs a composite signal by compositing the first signal and the second signal; and a processor that: (a) in a first period, controls the compositing circuit to output the first signal as the composite signal; (b) in a second period, controls the video processing circuit to perform changing of the pattern of the video processing performed by the video processing circuit, the second period being a period not included in the first period; and (c) in a change period, controls: the capture circuit to generate the second signal; and the compositing circuit to output the second signal as the composite signal, the change period being a period in which the changing is performed.

According to the above-described aspect, since the video signal processing device outputs the signal captured by the capture circuit in the period in which the video processing circuit switches the video processing, outputting of the video signal can be maintained even in the period in which the video processing circuit switches the video processing. Since the signal outputted by the video processing circuit is not outputted in the period in which the video processing circuit switches the video processing, it is possible to avoid outputting a video signal including noise. Accordingly, the video signal processing device can suppress muting of the video signal in the period in which the video processing circuit switches the video processing.

(2) The video signal processing device according to (1) further includes: a memory, wherein the processor controls the capture circuit to store, in the memory, the second signal generated by the capture circuit, and when a first time length corresponding to first latency that occurs in the video signal due to the video processing in a first pattern is different from a second time length corresponding to second latency that occurs in the video signal due to the video processing in a second pattern, the processor controls the compositing circuit to output, in the change period, the second signal whose elapsed time since being stored in the memory is a time length between the first time length and the second time length, the first pattern being a pattern before the changing among the plurality of video processing patterns, the second pattern being a pattern after the changing among the plurality of video processing patterns.

According to the above-described aspect, when the latency of the video processing before the changing (first latency) is different from the latency of the video processing after the changing (second latency), the video signal processing device can output the composite signal so that the difference in delay between the second signal and the first signal before and after the changing is reduced. Accordingly, the video signal processing device can appropriately change the latency due to switching of the video processing while suppressing muting of the video signal in the period of switching video processing. Moreover, the video signal processing device may achieve an effect of reducing discomfort of a user that may occur if the video signal is muted at a timing that is not intended by the user.

(3) The video signal processing device according to (2), wherein the processor controls the compositing circuit to cause the elapsed time of the second signal since being stored in the memory to change from the first time length toward the second time length, the second signal being outputted by the compositing circuit in the change period.

According to the above-described aspect, when the latency of the video processing before the changing (first latency) is different from the latency of the video processing after the changing (second latency), the video signal processing device can output the composite signal while causing the latency time to gradually change from the latency time before the changing to the latency time after the changing by causing the elapsed time of the second signal read out in the change period to change from the first time length toward the second time length. Accordingly, the video signal processing device can appropriately change the latency due to switching of the video processing while suppressing muting of the video signal in the period of switching video processing.

(4) The video signal processing device according to any one of (1) to (3), wherein the receiving interface receives a command to change the video processing performed on the video signal by the video processing circuit to lower-latency video processing, and when the receiving interface receives the command, in (b), the processor controls the video processing circuit to change the video processing performed on the video signal to the lower-latency video processing.

According to the above-described aspect, when the video processing performed on the video signal by the video processing circuit is changed to the lower-latency video processing, the video signal processing device can suppress muting of the video signal in the period of switching video processing.

(5) The video signal processing device according to any one of (1) to (4), wherein at a time immediately before or after the change period, the processor controls the compositing circuit to generate and output the composite signal by blending a pixel value included in the first signal with a pixel value included in the second signal.

According to the above-described aspect, the video signal processing device can suppress rapid change in image quality by using a pixel value obtained by blending the pixel value of the first signal with the pixel value of the second signal when a signal outputted as the composite signal is changed from one of the first signal and the second signal to the other of the first signal and the second signal. Accordingly, the video signal processing device can suppress rapid change in image quality due to switching of the video processing while suppressing muting of the video signal in the period of switching video processing.

(6) The video signal processing device according to any one of (1) to (5), wherein the compositing circuit includes an on-screen display (OSD) compositing circuit that composites the first signal and the second signal as an OSD signal.

According to the above-described aspect, the video signal processing device can composite the first signal and the second signal more easily by using the OSD compositing circuit for compositing the first signal and the second signal. Accordingly, the video signal processing device can more easily suppress muting of the video signal in the period of switching video processing.

(7) The video signal processing device according to any one of (1) to (6), wherein the compositing circuit further includes a muting circuit that switches whether to mute the first signal generated by the video processing circuit, and the processor controls the muting circuit to mute the first signal in the change period.

According to the above-described aspect, the video signal processing device can avoid outputting, as the composite signal, the first signal that may include noise by muting the first signal in the change period. In the change period, since the second signal is outputted as the composite signal in principle, the first signal is not outputted as the composite signal. However, when the compositing circuit operates in violation of the principle for some reason, the first signal that may include noise may be outputted as the composite signal. By the compositing circuit including the muting circuit, it is possible to avoid outputting, as the composite signal, the first signal that may include noise, as described above. Accordingly, while suppressing muting of the video signal in the period of switching video processing, the video signal processing device can suppress output of a video signal that may include noise.

(8) A video signal processing method that is performed by a video signal processing device that includes: a receiving interface that receives a video signal that represents a moving image; a video processing circuit that generates a first signal by performing video processing in a pattern among a plurality of video processing patterns in which the video processing circuit is capable of performing video processing on the video signal received by the receiving interface; a capture circuit that generates a second signal by capturing the video signal received by the receiving interface; a compositing circuit that outputs a composite signal by compositing the first signal and the second signal; and a processor. The video signal processing method includes the following executed by the processor: (a) in a first period, controlling the compositing circuit to output the first signal as the composite signal; (b) in a second period, controlling the video processing circuit to perform changing of the pattern of the video processing performed by the video processing circuit, the second period being a period not included in the first period; and (c) in a change period, controlling: the capture circuit to generate the second signal; and the compositing circuit to output the second signal as the composite signal, the change period being a period in which the changing is performed.

According to the above-described aspect, the same effect as the video signal processing device can be achieved.

(9) A program for causing a computer to execute the video signal processing method according to (8).

According to the above-described aspect, the same effect as the video signal processing device can be achieved.

Hereinafter, an embodiment will be described in detail with reference to the Drawings as necessary. However, there may be an instance where excessively detailed description is omitted. For example, details regarding known facts or duplicate explanation of essentially identical configurations may be omitted. This is to avoid redundancy and to make the following description easier for those skilled in the art to understand.

It should be noted that the Drawings and the following description are provided by the inventor(s) to facilitate sufficient understanding of the present disclosure by those skilled in the art, and are thus not intended to limit the scope of the subject matter recited in the claims.

### Embodiment

In the present embodiment, a video signal processing device (also referred to as a processing device) or the like that suppresses muting of a video signal in a period of switching video processing will be described.

### 1. Configuration of System 1

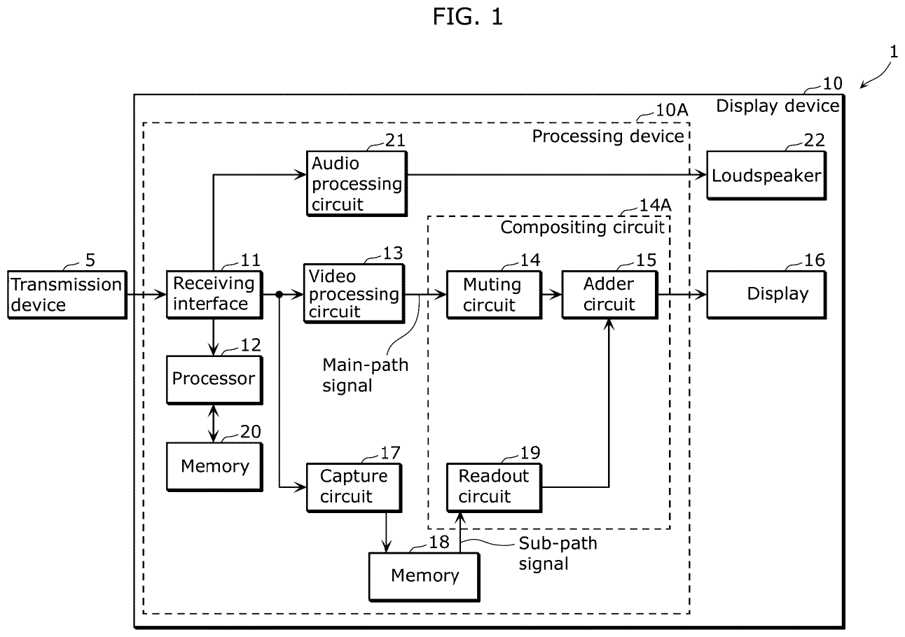

FIG. 1 is an explanatory diagram illustrating a configuration of system 1 according to the present embodiment and a configuration of display device 10 that includes processing device 10A.

As illustrated in FIG. 1, system 1 includes transmission device 5 and display device 10. It should be noted that it can also be said that system 1 includes transmission device 5 and processing device 10A.

Transmission device 5 is a device that transmits, to display device 10, a video signal including a moving image. The communication standard of the video signal transmitted by transmission device 5 is, for example, the HDMI (registered trademark) 2.1 standard. It should be noted that transmission device 5 may transmit, to display device 10, an audio signal together with the video signal.

Moreover, transmission device 5 can transmit, to display device 10 (more specifically, processing device 10A), a command (also referred to as a change command) for changing video processing performed on the video signal by display device 10. Transmission device 5 can transmit the change command as a communication packet (also referred to as a change command packet).

For example, the change command may include: a command for changing video processing performed on the video signal by display device 10 to lower-latency video processing; or a command for changing video processing performed on the video signal by display device 10 to higher-latency video processing. Here, a case in which the change command is a command for changing video processing performed on the video signal by display device 10 to lower-latency video processing will be described as an example.

It should be noted that “lower-latency video processing” can be rephrased as video processing performed with latency that is lower than standard latency, and can also be said to be video processing performed with a processing time that is shorter than a standard processing time. Likewise, “higher-latency video processing” can be rephrased as video processing performed with latency that is higher than the standard latency, and can also be said to be video processing performed with a processing time that is longer than the standard processing time.

The command for changing video processing performed on the video signal by display device 10 to lower-latency video processing is, for example, achieved by the ALLM function in the HDMI (registered trademark) 2.1 standard. A timing at which transmission device 5 transmits the change command is, for example, a timing at which the content of the moving image included in the video signal transmitted by transmission device 5 is switched.

For example, transmission device 5 is a gaming device. In this case, transmission device 5 that is a gaming device transmits a change command when switching a normal video signal to a video signal in which a delay in a user's response to the progress of a moving image is determined to have a relatively big influence on the progress of a game (e.g., a video signal of a fighting game or the like).

Display device 10 is a device that displays, as a moving image, a video signal transmitted by transmission device 5. Display device 10 includes processing device 10A that performs video processing on the video signal transmitted by transmission device 5.

Processing device 10A is a video signal processing device that suppresses muting of a video signal in a period of switching video processing. Processing device 10A performs video processing on a video signal and causes display 16 to display, as video, the video signal on which the video processing has been performed. Processing device 10A can perform changing of video processing performed on a video signal, and a period in which the changing is performed is also called a change period.

### 2. Configuration of Display Device 10

Display device 10 includes receiving interface 11, processor 12, video processing circuit 13, compositing circuit 14A, display 16, capture circuit 17, memories 18 and 20, audio processing circuit 21, and loudspeaker 22.

For example, compositing circuit 14A is configured to include muting circuit 14, adder circuit 15, and readout circuit 19, as illustrated in FIG. 1.

It should be noted that processing device 10A corresponds to a part that includes, among the constituent elements included in display device 10, receiving interface 11, processor 12, video processing circuit 13, muting circuit 14, adder circuit 15, capture circuit 17, memories 18 and 20, readout circuit 19, and audio processing circuit 21.

It should be noted that among the constituent elements included in display device 10, part or all of processor 12, video processing circuit 13, muting circuit 14, adder circuit 15, capture circuit 17, readout circuit 19, and audio processing circuit 21 may be configured as a single chip of large scale integration (LSI) or the like.

### 2-1. Receiving Interface 11

Receiving interface 11 is an interface device that receives a video signal that represents a moving image and is transmitted by transmission device 5. The video signal that represents the moving image is a signal in which a plurality of still images (also referred to as a plurality of frames) constituting the moving image are arranged in a time direction. Receiving interface 11 provides the video signal received to video processing circuit 13. It should be noted that the constituent elements included in display device 10 process the video signal on a per-frame basis.

When transmission device 5 transmits an audio signal, receiving interface 11 receives the audio signal transmitted by transmission device 5 together with the above-described video signal. Receiving interface 11 provides the audio signal received to audio processing circuit 21.

Moreover, receiving interface 11 receives a change command packet transmitted by transmission device 5. The change command packet is a command for changing video processing performed on the video signal by video processing circuit 13 to lower-latency video processing. Transmission device 5 provides the change command packet received to processor 12.

### 2-2. Processor 12

Processor 12 is a circuit that controls circuits included in display device 10. Processor 12 is, for example, a central processing unit (CPU). Processor 12 is connected, by a control line, to the circuits that are included as constituent elements in display device 10. It should be noted that the control line that connects processor 12 and the circuits included as the constituent elements in display device 10 is omitted for illustrative purposes.

Processor 12 can control the circuits included in display device 10 by executing a predetermined program. The above-described program may be stored in memory 20 or another storage device. Examples of circuit control performed by processor 12 will be listed and explained below.

### (1) Determination of Signal to be Outputted as Composite Signal

Processor 12 determines an output signal that is outputted as a composite signal by compositing circuit 14A. Specifically, in a first period, processor 12 controls compositing circuit 14A to output, as a composite signal, a signal (also referred to as a first signal or a main-path signal) that is generated by video processing circuit 13 performing video processing. The first period is a period not included in a second period described below.

Moreover, in a period not included in the first period (also referred to as a second period), processor 12 controls video processing circuit 13 to perform changing of the pattern of the video processing performed by video processing circuit 13. A period in which video processing circuit 13 performs the changing of the pattern of the video processing corresponds to a change period. The change period is included in the second period.

Then, in the second period, processor 12 controls capture circuit 17 to capture a video signal to generate a signal (also referred to as a second signal or a sub-path signal), and controls compositing circuit 14A to output the sub-path signal as a composite signal. As described above, since the period in which video processing circuit 13 performs the changing of the pattern of the video processing in the second period corresponds to the change period, it can also be said that, in the change period, processor 12 controls capture circuit 17 to capture a video signal to generate a signal (also referred to as a second signal or a sub-path signal) and controls compositing circuit 14A to output the sub-path signal as a composite signal.

### (2) Determination of Frames to be Reproduced in Second Period

Processor 12 controls capture circuit 17 to store, in memory 18, a sub-path signal generated by capture circuit 17. In this case, when a time length (also referred to as a first time length) corresponding to latency (also referred to as first latency) that occurs in a video signal due to video processing in a pattern prior to changing (also referred to as a first pattern) among a plurality of video processing patterns is different from a time length (also referred to as a second time length) corresponding to latency (also referred to as second latency) that occurs in the video signal due to video processing in a pattern subsequent to the changing (also referred to as a second pattern) among the plurality of video processing patterns, processor 12 controls compositing circuit 14A to read out and output, in a second period, from memory 18, the sub-path signal whose elapsed time since being stored in memory 18 is a time length between the first time length and the second time length. As described above, since a period in which video processing circuit 13 performs the changing of the pattern of video processing in the second period corresponds to a change period, it can also be said that, in the above-described case, in the change period, processor 12 controls compositing circuit 14A to read out and output, from memory 18, the sub-path signal whose elapsed time since being stored in memory 18 is a time length between the first time length and the second time length.

At this time, processor 12 can control readout circuit 19 so that the elapsed time of the sub-path signal, which is to be read out from memory 18 by readout circuit 19 in the change period (i.e., the second period), since being stored in memory 18 changes from the first time length toward the second time length. More specifically, processor 12 can: determine frames to be read out by readout circuit 19 so that a playback speed rate at which the frames read out by readout circuit 19 are reproduced in the second period becomes playback speed rate P; and control readout circuit 19 to read out the frames determined.

More specifically, frames that are reproduced by processor 12 in the second period are determined as described below.

First, processor 12 calculates time length Td that denotes a time length from when compositing circuit 14A starts outputting the sub-path signal to when compositing circuit 14A completes the outputting (i.e., a time length for which compositing circuit 14A outputs the sub-path signal), by using first latency Dpre, second latency Dpost, time length Tc that is required for setting change, and (Equation 1) shown below.

Td=Tc+Dpost (Equation 1)

It should be noted that time length Td denotes a time length for which compositing circuit 14A outputs the sub-path signal when there are no upper-limit value and no lower-limit value in playback speed rate P described below.

Then, processor 12 calculates playback speed rate (also simply referred to as rate) P of the video signal in the second period, by using time length Td and (Equation 2) shown below.

P=1+(Dpre−Dpost)/Td (Equation 2)

Then, processor 12 identifies number Fr(n) of an n-th (n≥1) frame in the sub-path signal read out from memory 18 by readout circuit 19 in the second period, by using (Equation 3) shown below. In (Equation 3), ROUND( ) is a function that rounds a value inside the parenthesis to the nearest integer, and F0 is the number of a frame outputted by adder circuit 15 immediately before the second period.

Fr(n)=F0+Round(P×n) (Equation 3)

It should be noted that when there is an upper-limit value or a lower-limit value in playback speed rate P, processor 12 can calculate playback speed rate P as described below.

Namely, when playback speed rate P calculated by using (Equation 2) is higher than upper-limit value Pmax, playback speed rate P is set to upper-limit value Pmax and time length Td is calculated by using (Equation 4) shown below. Time length Td denotes a time length from when outputting of the sub-path signal is started to when the outputting is completed.

Td=(Dpre−Dpost)/(Pmax−1) (Equation 4)

There is a possibility that discomfort a user may feel can be reduced by using time length Td calculated by using (Equation 4). Time length Td calculated by using the above-described (Equation 1) is a minimum required time length that is calculated from time length Tc required for the change processing and latency Dpost after the change. When playback speed rate P calculated from time length Td is too high (e.g., when playback speed rate P is higher than Pmax), time length Td that is longer than time length Td calculated by using (Equation 1) is obtained by calculating time length Td so that playback speed rate P does not exceed Pmax as shown in the above-described (Equation 4). By using time length Td obtained as described above, an effect of suppressing an excessive increase in a playback speed is achieved although a certain amount of time is required until switching again to a main-path signal.

Moreover, when playback speed rate P calculated by using (Equation 2) is lower than lower-limit value Pmin, playback speed rate P is set to lower-limit value Pmin and time length Td is calculated by using (Equation 5) shown below. Similar to the above, time length Td denotes a time length from when outputting of the sub-path signal is started to when the outputting is completed.

Td=(Dpre−Dpost)/(Pmin−1) (Equation 5)

Similar to the above, there is a possibility that discomfort a user may feel can be reduced by using time length Td calculated by using (Equation 5).

For example, upper-limit value Pmax may be approx. 1.1 to 1.2, and lower-limit value Pmin may be approx. 0.8 to 0.9.

Moreover, when there is a constraint that the time length of the second period is set to predetermined fixed time length Tf, upper-limit value Pmax and lower-limit value Pmin in (Equation 6) and (Equation 7) shown below can be used. Here, Dmax denotes a maximum value of the difference between latency Dpre of video processing before the change and latency Dpost of video processing after the change in a case where various combinations of video processing patterns before and after the change are taken into consideration. For example, time length Tf may be approx. one second.

Pmax=1+Dmax/Tf (Equation 6)

Pmin=1−Dmax/Tf (Equation 7)

### (3) Setting Change of Pattern of Video Processing

Processor 12 performs setting change of the pattern of video processing performed on a video signal by video processing circuit 13. Specifically, when receiving interface 11 receives a change command packet, processor 12 controls video processing circuit 13 to perform changing of video processing performed on a video signal by video processing circuit 13 to lower-latency video processing or higher-latency video processing. Here, an example in which, when receiving interface 11 receives a change command packet, processor 12 controls video processing circuit 13 to perform changing of video processing performed on a video signal by video processing circuit 13 to lower-latency video processing is described.

Moreover, at a time immediately before or after a second period, processor 12 can control adder circuit 15 to generate and output, as a composite signal, a frame having a pixel value obtained by blending a pixel value included in a frame of a main-path signal with a pixel value included in a frame of a sub-path signal.

Generation of a composite signal by blending pixel values will be described in Variation described below.

### (4) Muting of Main-Path Signal

Processor 12 controls muting circuit 14 to mute a main-path signal in a second period.

### 2-3. Video Processing Circuit 13

Video processing circuit 13 performs video processing on a video signal received by receiving interface 11. Video processing circuit 13 provides, to muting circuit 14, the video signal on which the video processing has been performed. The video processing performed on the video signal by video processing circuit 13 will be described later in detail.

Specifically, video processing circuit 13 generates a first signal (corresponding to a main-path signal) by performing video processing in a pattern among a plurality of video processing patterns in which video processing circuit 13 can perform video processing on a video signal received by receiving interface 11. The video processing in the above-described pattern performed on the video signal by video processing circuit 13 may be set by processor 12.

When receiving interface 11 receives a change command packet, video processing circuit 13 changes, under the control of processor 12, the video processing performed by video processing circuit 13 to lower-latency video processing.

### 2-4. Compositing Circuit 14A

Compositing circuit 14A outputs a composite signal by compositing a main-path signal and a sub-path signal. Specifically, a composite signal is generated by compositing a main-path signal provided from video processing circuit 13 and a sub-path signal read out from memory 18. Then, compositing circuit 14A provides the composite signal generated to display 16.

In a first period, compositing circuit 14A outputs a main-path signal under the control of processor 12. Moreover, in a second period, compositing circuit 14A outputs a sub-path signal under the control of processor 12. Since a change period is included in the second period, it can also be said that compositing circuit 14A outputs a sub-path signal in the change period.

For example, compositing circuit 14A is configured to include muting circuit 14, adder circuit 15, and readout circuit 19, as illustrated in FIG. 1, and this example will be described here.

Muting circuit 14, adder circuit 15, and readout circuit 19 operate as described below when compositing circuit 14A outputs a main-path signal.
Muting circuit 14 does not mute a main-path signal but outputs the main-path signal.
Readout circuit 19 does not read out a sub-path signal.
Adder circuit 15 outputs the main-path signal as a composite signal (opacity r of the sub-path signal described below is 0).

Moreover, muting circuit 14, adder circuit 15, and readout circuit 19 operate as described below when compositing circuit 14A outputs a sub-path signal.
Muting circuit 14 mutes a main-path signal.
Readout circuit 19 reads out a sub-path signal.
Adder circuit 15 outputs the sub-path signal as a composite signal (opacity r of the sub-path signal described below is 1).

It should be noted that, as another configuration of compositing circuit 14A, there may be a configuration in which compositing circuit 14A includes, instead of muting circuit 14, a memory and a readout circuit. In this case, a video signal provided from video processing circuit 13 is stored in memory 18, and the above-described readout circuit reads out the video signal stored in the above-described memory and provides the video signal to adder circuit 15.

### 2-5. Muting Circuit 14

Muting circuit 14 switches whether to mute a main-path signal inputted into muting circuit 14 under the control of processor 12. When muting circuit 14 does not mute the main-path signal inputted into muting circuit 14, muting circuit 14 outputs the main-path signal as it is. Moreover, when muting circuit 14 mutes the main-path signal inputted into muting circuit 14, muting circuit 14 outputs, as the main-path signal, a video signal in which all pixels are black.

Under the control of processor 12, muting circuit 14 provides, as the main-path signal, the video signal in which all pixels are black to adder circuit 15 by muting the main-path signal in a second period. As described above, since a period in which video processing circuit 13 performs changing of the pattern of video processing in the second period corresponds to a change period, it can also be said that, under the control of processor 12, muting circuit 14 provides, as the main-path signal, the video signal in which all pixels are black to adder circuit 15 by muting the main-path signal in the change period.

It should be noted that muting circuit 14 is not essential in display device 10. When display device 10 does not include muting circuit 14, video processing circuit 13 is connected to adder circuit 15. Adder circuit 15 described later can cause opacity r of a sub-path signal (more specifically, an OSD signal) to be 1 to composite a main-path signal and the sub-path signal in the same manner as a state in which muting circuit 14 mutes the main-path signal.

### 2-6. Adder Circuit 15

Adder circuit 15 outputs a composite signal by compositing a main-path signal and a sub-path signal. Specifically, adder circuit 15 generates a composite signal by compositing a main-path signal provided from muting circuit 14 and a sub-path signal provided from readout circuit 19. Then, adder circuit 15 provides the composite signal generated to display 16.

When a first time length corresponding to first latency that occurs in a video signal due to video processing in a first pattern is different from a second time length corresponding to second latency that occurs in the video signal due to video processing in a second pattern, adder circuit 15 outputs, under the control of processor 12, in a second period, a sub-path signal whose elapsed time since being stored in memory 18 is a time length between the first time length and the second time length. As described above, since a period in which video processing circuit 13 performs changing of the pattern of video processing in the second period corresponds to a change period, it can also be said that, in the above-described case, adder circuit 15 outputs, in the change period, the sub-path signal whose elapsed time since being stored in memory 18 is a time length between the first time length and the second time length.

The sub-path signal outputted by adder circuit 15 is a sub-path signal that has been stored in memory 18 and read out from memory 18 by readout circuit 19.

Moreover, the elapsed time since the sub-path signal to be outputted by adder circuit 15 in the second period has been stored in memory 18 is controlled by processor 12 so that the elapsed time changes from the first time length toward the second time length. As described above, since a period in which video processing circuit 13 performs changing of the pattern of video processing in the second period corresponds to a change period, it can also be said that the elapsed time since the sub-path signal to be outputted by adder circuit 15 in the change period has been stored in memory 18 is controlled by processor 12 so that the elapsed time changes from the first time length toward the second time length.

This is based on the fact that readout circuit 19 reads out the sub-path signal from memory 18 so that the elapsed time since the sub-path signal to be read out from memory 18 by readout circuit readout circuit 19 in the second period has been stored in memory 18 changes from the first time length toward the second time length.

At a time immediately before or after the second period, under the control of processor 12, adder circuit 15 can generate and output a composite signal by blending a pixel value included in a main-path signal with a pixel value included in the sub-path signal. As described above, since a period in which video processing circuit 13 performs changing of the pattern of video processing in the second period corresponds to a change period, it can also be said that, at a time immediately before or after the change period, adder circuit 15 can generate and output the composite signal by blending a pixel value included in the main-path signal with a pixel value included in the sub-path signal.

Adder circuit 15 may be achieved as an on-screen display (OSD) compositing circuit. In this case, the OSD compositing circuit that is adder circuit 15 composites a main-path signal and a sub-path signal as an on-screen display (OSD) signal. The OSD compositing circuit is generally a circuit that superimposes, on a video signal to be displayed, a signal (also referred to as an OSD signal) that represents an image of a channel number, a sound volume, or the like. The opacity of the OSD signal when the OSD signal is superimposed on the video signal is controllable within a range of 0% to 100%.

In display device 10, the OSD compositing circuit functions as adder circuit 15 by using “the video signal to be displayed” as a main-path signal and the OSD signal as a sub-path signal. Pixel value D included in a frame of the composite signal outputted by adder circuit 15 is a pixel value obtained by blending pixel value Sm included in a frame of the main-path signal with pixel value Ss included in a frame of the sub-path signal, using (Equation 8) shown below. In (Equation 8), r denotes the opacity of the OSD signal. It can also be said that pixel value D denotes a weighted average where the weight for pixel value Sm is (1−r) and the weight for pixel value Ss is r.

D=Sm×(1−r)+Ss×R (Equation 8)

For example, when the opacity of the sub-path signal that is the OSD signal is 0%, the composite signal outputted by adder circuit 15 is the same as the main-path signal. This corresponds to the fact that (Equation 9) shown below is satisfied when r=0 is satisfied in (Equation 8).

D=Sm (Equation 9)

Moreover, for example, when the opacity of the sub-path signal that is the OSD signal is 100%, the composite signal outputted by adder circuit 15 is the same as the sub-path signal. This corresponds to the fact that (Equation 10) shown below is satisfied when r=1 is satisfied in (Equation 8).

D=Ss (Equation 10)

Moreover, for example, when the opacity of the sub-path signal that is the OSD signal is 50%, the pixel value of the frame of the composite signal outputted by adder circuit 15 is an average value of the pixel value included in the frame of the main-path signal and the pixel value included in the frame of the sub-path signal. This corresponds to the fact that (Equation 11) shown below is satisfied when r=0.5 is satisfied in (Equation 8).

D=0.5×Sm+0.5×Ss (Equation 11)

### 2-7. Display 16

Display 16 displays, as video, a composite signal provided from adder circuit 15. Display 16 may be, for example, a liquid crystal panel or an organic electro-luminescence (EL) panel. It is assumed that the video displayed by display 16 is viewed by a user.

### 2-8. Capture Circuit 17

Capture circuit 17 generates a sub-path signal by capturing a video signal received by receiving interface 11. Capture circuit 17 stores, in memory 18, the sub-path signal generated. Under the control of processor 12, capture circuit 17 stores, in memory 18, the sub-path signal generated by capturing.

### 2-9. Memory 18

Memory 18 is a storage device that can store a video signal. Memory 18 may be a volatile storage device such as a dynamic random access memory (DRAM), or may be a non-volatile storage device such as a hard disk drive (HDD) or a solid state drive (SSD). A sub-path signal generated by capture circuit 17 is stored in memory 18 by capture circuit 17, and the sub-path signal stored is read out by readout circuit 19.

### 2-10. Readout Circuit 19

Readout circuit 19 reads out a sub-path signal stored in memory 18. Readout circuit 19 provides, to adder circuit 15, the sub-path signal read out.

Under the control of processor 12, readout circuit 19 sequentially reads out, as frames read out by readout circuit 19, frames determined by processor 12.

When a first time length corresponding to first latency that occurs in a video signal due to video processing in a first pattern is different from a second time length corresponding to second latency that occurs in the video signal due to video processing in a second pattern, under the control of processor 12, readout circuit 19 can read out, in a second period, from memory 18, a sub-path signal whose elapsed time since being stored in memory 18 is a time length between the first time length and the second time length, and can provide the sub-path signal to adder circuit 15. As described above, since a period in which video processing circuit 13 performs changing of the pattern of video processing in the second period corresponds to a change period, it can also be said that, in the above-described case, readout circuit 19 can read out, in the change period, the sub-path signal whose elapsed time since being stored in memory 18 is a time length between the first time length and the second time length, and can provide the sub-path signal to adder circuit 15.

Moreover, under the control of processor 12, readout circuit 19 can read out the sub-path signal from memory 18 so that the elapsed time since the sub-path signal to be read out from memory 18 in the second period has been stored in memory 18 changes from the first time length toward the second time length. As described above, since a period in which video processing circuit 13 performs changing of the pattern of video processing in the second period corresponds to a change period, it can also be said that readout circuit 19 can read out the sub-path signal from memory 18 so that the elapsed time since the sub-path signal to be read out from memory 18 in the change period has been stored in memory 18 changes from the first time length toward the second time length.

A number for identifying a frame read out from memory 18 by readout circuit 19 is calculated by using the above-described (Equation 3). It should be noted that when readout circuit 19 does not read out a frame, readout circuit 19 provides nothing to adder circuit 15; however, at this time, readout circuit 19 may provide, to adder circuit 15, an image in which all pixels are black.

It should be noted that readout circuit 19 may perform video decompression processing on a frame read out. This is based on the premise that capture circuit 17 had performed video compression processing on the frame and then stored the frame in memory 18. Thus, the amount of video signal data stored in memory 18 can be made small, and therefore the capacity of memory 18 can be made small.

It should be noted that readout circuit 19 may be included as a function of adder circuit 15 in adder circuit 15. In other words, adder circuit 15 may read out the sub-path signal stored in memory 18.

### 2-11. Memory 20

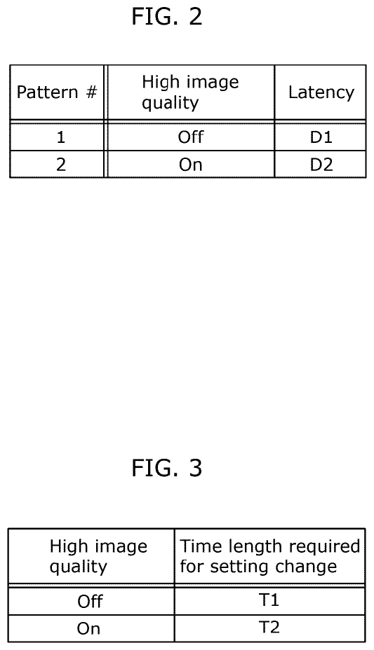

Memory 20 is a storage device that can store various information. Memory 20 may be a non-volatile storage device and may be, for example, a flash memory. Memory 20 stores a program, information indicating a video processing pattern (see FIG. 2), and information indicating a time length required for setting change of video processing (see FIG. 3) that are read out by processor 12.

### 2-12. Audio Processing Circuit 21

Audio processing circuit 21 performs audio processing on an audio signal received by receiving interface 11. Audio processing circuit 21 provides, to loudspeaker 22, the audio signal on which the audio processing has been performed.

Audio processing circuit 21 may include a buffer (not illustrated). In this case, audio processing circuit 21 can adjust, by temporarily storing the audio signal in the buffer, a timing at which the audio signal on which the audio processing has been performed is provided to loudspeaker 22.

Specifically, audio processing circuit 21 identifies, by using (Equation 12) shown below, number Sr(n) of an audio signal that is an n-th audio signal read out from the buffer in a second period. In (Equation 12), S0 denotes the number of an audio signal outputted by audio processing circuit 21 immediately before the second period.

Sr(n)=S0+ROUND(P×n) (Equation 12)

It should be noted that an audio signal outputted to loudspeaker 22 by audio processing circuit 21 in the second period may be an audio signal that includes time stamp T calculated by (Equation 13) shown below. In (Equation 13), Tn denotes an elapsed time since reproduction of the audio signal has started, and Tpast denotes an elapsed time since the second period has started until the current time.

T=Tn+Dpre+Tpast×P (Equation 13)

It should be noted that it is assumed that a time stamp is provided in advance to an audio signal received by receiving interface 11. For example, when the standard of a video signal is MPEG2-TS, a presentation time stamp (PTS) can be used as a time stamp.

### 2-13. Loudspeaker 22

Loudspeaker 22 outputs, as audio, an audio signal provided from audio processing circuit 21. It is assumed that the audio outputted by loudspeaker 22 is heard by a user.

### 3. Video Processing

Video processing performed on a video signal by video processing circuit 13 will be described in detail with reference to FIG. 2.

FIG. 2 is an explanatory diagram illustrating a pattern table that indicates a plurality of video processing patterns according to the present embodiment.

The pattern table illustrated in FIG. 2 shows video processing types and latency in association with the plurality of video processing patterns. The pattern table shown in FIG. 2 is stored in, for example, memory 20, and processor 12 can read out and use the pattern table as needed.

A video processing pattern is a pattern of video processing that can be performed on a video signal by video processing circuit 13. Each pattern indicates that whether video processing that can be performed on a video signal by video processing circuit 13 is performed on a video signal or not.

Specifically, the pattern table indicates, for each pattern, that whether video processing circuit 13 performs video processing in the pattern on a video signal (denoted as “On”) or not (denoted as “Off”).

In FIG. 2, high image quality video processing (denoted as “high image quality”) is shown as an example of video processing that can be performed on a video signal by video processing circuit 13.

Video processing circuit 13 generally includes a plurality of types of video processing means for enhancing or improving the image quality of a video. Examples of the plurality of types of video processing means may include noise reduction, sharpness correction, tone correction, gamma correction, and the like.

In video processing pattern 1 shown in FIG. 2 (i.e., in a pattern in which high image quality video processing is Off), by not performing part of the above-described plurality of types of video processing means on a video signal, a time length required for video processing is reduced compared to when all of the above-described plurality of types of video processing means are performed on the video signal. Thus, low-latency video processing is achieved.

In contrast, in video processing pattern 2 shown in FIG. 2 (i.e., in a pattern in which high image quality video processing is On), all of the above-described video processing means are performed on a video signal. Thus, high image quality video processing is achieved.

It should be noted that video processing that can be performed on a video signal by video processing circuit 13 is not limited to high image quality video processing and may include other video processing.

It should be noted that low-latency video processing may be video processing for games, in other words, video processing designed specifically for game play, and may be generally referred to as “game mode” or the like. Meanwhile, high image quality video processing may be video processing for applications that do not require low-latency.

The latency column indicates latency that occurs in a video signal when video processing circuit 13 performs video processing in the corresponding pattern on the video signal. Although latency is represented in units of time for example, the present disclosure is not limited to this example and latency may be represented in units of the number of frames. Latency represented in units of time and latency represented in units of the number of frames are mutually convertible by multiplication or division using a frame rate (fps) of a video signal. Specifically, latency represented in units of the number of frames is calculated by multiplying latency represented in units of time by a frame rate. In contrast, latency represented in units of time is calculated by dividing latency represented in units of the number of frames by a frame rate.

As illustrated in FIG. 2, pattern 1 is a video processing pattern in which high image quality video processing is not performed on a video signal (Off). Pattern 1 is a video processing pattern in which video processing is performed with latency lower than that achieved when high image quality video processing is performed (when video processing in pattern 2 is performed). The latency that occurs in a video signal when video processing circuit 13 performs video processing in pattern 1 is denoted as D1.

Pattern 2 is a video processing pattern in which high image quality video processing is performed on a video signal (On). Pattern 2 is a video processing pattern in which video processing is performed with latency higher than that achieved when low-latency video processing is performed (when video processing in pattern 1 is performed). The latency that occurs in a video signal when video processing circuit 13 performs video processing in pattern 2 is denoted as D2, and D2 is greater than D1.

FIG. 3 is an explanatory diagram illustrating a time table that indicates time length Tc required for setting change of video processing according to the present embodiment. The time table illustrated in FIG. 3 is stored in memory 20 for example, and processor 12 can read out and use the time table as needed.

In FIG. 3, time length Tc required for setting change is shown for each video processing type. The time length required for setting change is a time length required for setting video processing of the corresponding type as video processing performed by video processing circuit 13.

In FIG. 3, a time length required for setting video processing circuit 13 to perform low-latency video processing is denoted as T1, and a time length required for setting video processing circuit 13 to perform high image quality video processing is denoted as T2.

### 4. Composite Processing

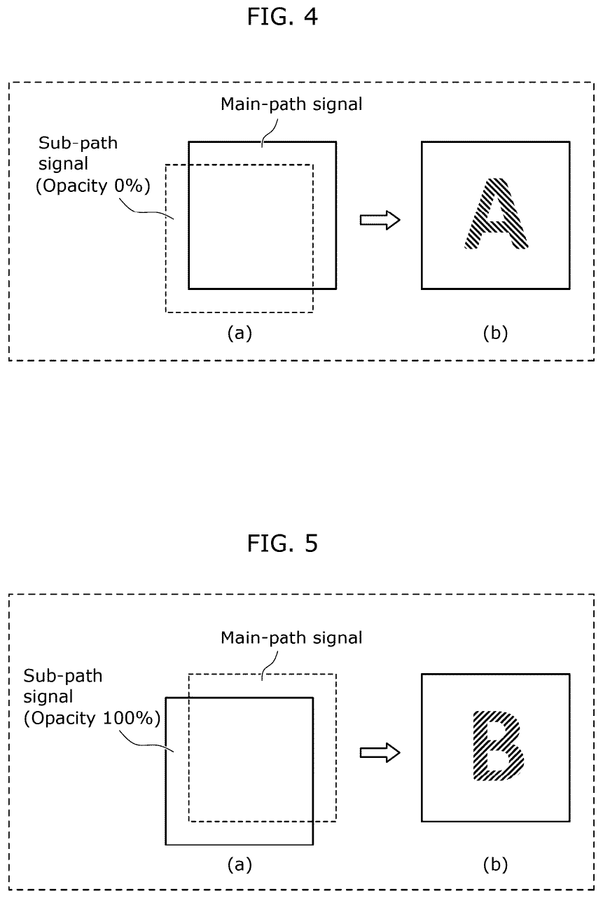

Composite processing performed on a main-path signal and a sub-path signal by adder circuit 15 will be described in detail with reference to FIG. 4 to FIG. 6.

FIG. 4 is a first explanatory diagram illustrating composite processing performed by adder circuit 15 according to the present embodiment.

FIG. 4 illustrates the concept of the composite processing when adder circuit 15 outputs a main-path signal as a composite signal.

Adder circuit 15 composites the main-path signal and a sub-path signal that has opacity of 0% (see (a) in FIG. 4). In this case, r=0 is satisfied in (Equation 8), and pixel value D included in a frame of the composite signal is equal to pixel value Sm included in a frame of the main-path signal (see (Equation 9)).

For example, when an image of a letter “A” is included in the main-path signal and an image of a letter “B” is included in the sub-path signal, the composite signal includes the image of the letter “A” (see (b) in FIG. 4).

FIG. 5 is a second explanatory diagram illustrating composite processing performed by adder circuit 15 according to the present embodiment.

FIG. 5 illustrates the concept of the composite processing when adder circuit 15 outputs a sub-path signal as a composite signal.

Adder circuit 15 composites a main-path signal and the sub-path signal that has opacity of 100% (see (a) in FIG. 5). In this case, r=1 is satisfied in (Equation 8), and pixel value D included in a frame of the composite signal is equal to pixel value Ss included in a frame of the sub-path signal (see (Equation 10)).

For example, when an image of a letter “A” is included in the main-path signal and an image of a letter “B” is included in the sub-path signal, the composite signal includes the image of the letter “B” (see (b) in FIG. 5).

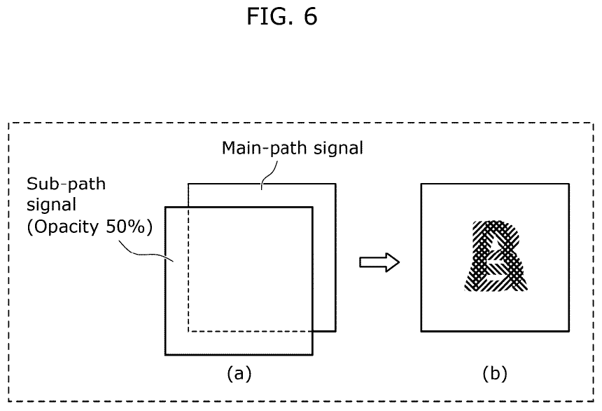

FIG. 6 is a third explanatory diagram illustrating composite processing performed by adder circuit 15 according to the present embodiment.

FIG. 6 illustrates the concept of the composite processing when adder circuit 15 outputs, as a composite signal, a frame having a pixel value obtained by blending a pixel value included in a frame of a main-path signal with a pixel value included in a frame of a sub-path signal.

Adder circuit 15 composites the main-path signal and the sub-path signal that has opacity of 50% (see (a) in FIG. 6). In this case, r=0.5 is satisfied in (Equation 8), and pixel value D included in the frame of the composite signal is an average value of pixel value Sm included in the frame of the main-path signal and pixel value Ss included in the frame of the sub-path signal (see (Equation 11)).

For example, when an image of a letter “A” is included in the main-path signal and an image of a letter “B” is included in the sub-path signal, the composite signal includes an image in which the image of the letter “A” and the image of the letter “B” overlap with each other (see (b) in FIG. 6).

### 5. Processing

Processing performed by system 1 that is configured as above will be described.

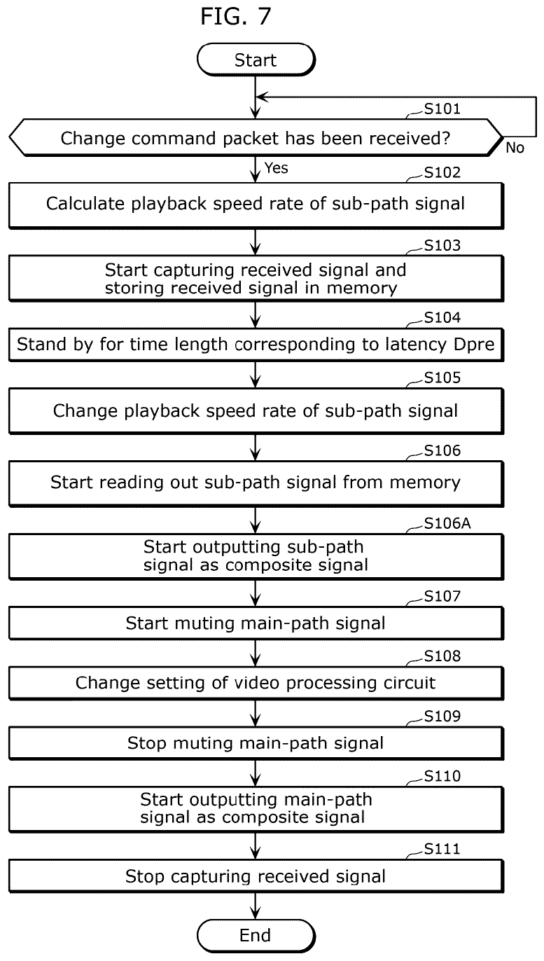

FIG. 7 is a flowchart showing processing performed by processor 12 when changing video processing according to the present embodiment.

At step S101, processor 12 determines whether receiving interface 11 has received a change command packet. When it is determined that receiving interface 11 has received a change command packet (Yes at step S101), the processing proceeds to step S102, and when it is determined that receiving interface 11 has not yet received a change command packet (No at step S101), the processing performs step S101 again. In other words, processor 12 stands by at step S101 until receiving interface 11 receives a change command packet.

At step S102, processor 12 calculates playback speed rate P of a sub-path signal. Playback speed rate P of the sub-path signal calculated by processor 12 will be used at step S105 described later.

At step S103, processor 12 controls capture circuit 17 to start capturing a received signal and storing the received signal captured in memory 18. Under the control of processor 12, capture circuit 17 starts capturing a received signal and storing the received signal captured in memory 18.

At step S104, processor 12 stands by for a time length corresponding to latency Dpre. In this standby time, one or more frames corresponding to latency Dpre are captured and stored in memory 18 by capture circuit 17.

At step S105, processor 12 controls readout circuit 19 to change playback speed rate P of the sub-path signal. Under the control of processor 12, readout circuit 19 changes playback speed rate P of the sub-path signal. Changing playback speed rate P of the sub-path signal by readout circuit 19 means starting sequentially determining frames to be read out by readout circuit 19 so that a playback speed rate at which the frames read out by readout circuit 19 are reproduced becomes playback speed rate P calculated at step S102.

At step S106, processor 12 controls readout circuit 19 to start reading out, as the sub-path signal, the frames stored in memory 18. Under the control of processor 12, readout circuit 19 starts reading out, as the sub-path signal, the frames determined at step S105 among frames stored in memory 18. Readout circuit 19 provides the sub-path signal read out to adder circuit 15.

At step S106A, processor 12 controls adder circuit 15 to start outputting the sub-path signal as a composite signal. Under the control of processor 12, adder circuit 15 starts outputting the sub-path signal as a composite signal.

At step S107, processor 12 controls muting circuit 14 to start muting a main-path signal. Under the control of processor 12, muting circuit 14 starts muting a main-path signal (i.e., a signal outputted by video processing circuit 13).

It should be noted that steps S105, S106, S106A, and S107 may be performed in any order as long as they are performed between a point of time immediately after when standing by at step S104 has been completed and a point of time at which adder circuit 15 actually outputs the sub-path signal as a composite signal (time t7 in a specific example described later).

At step S108, processor 12 changes a setting of video processing circuit 13. A time length required for changing the setting of video processing circuit 13 is as shown in FIG. 3.

At step S109, processor 12 controls muting circuit 14 to stop muting the main-path signal. Under the control of processor 12, muting circuit 14 stops muting the main-path signal (i.e., the signal outputted by video processing circuit 13). Muting of the main-path signal is stopped when time length Td has been passed from when changing of the setting of video processing circuit 13 (step S108) has started.

At step S110, processor 12 controls adder circuit 15 to start outputting the main-path signal as a composite signal. Under the control of processor 12, adder circuit 15 starts outputting the main-path signal (i.e., the signal outputted by muting circuit 14) as a composite signal.

At step S111, processor 12 controls capture circuit 17 to stop capturing the received signal. Under the control of processor 12, capture circuit 17 stops capturing the received signal. Moreover, processor 12 controls readout circuit 19 to stop reading out the frames stored in memory 18. Under the control of processor 12, readout circuit 19 stops reading out the frames stored in memory 18.

It should be noted that steps S109, S110, and S111 may be performed in any order as long as they are performed between a point of time immediately after when setting change at step S108 has been completed and a point of time at which adder circuit 15 actually outputs the main-path signal as a composite signal (time t11 in a specific example described later).

By the set of processes illustrated in FIG. 7, display device 10 can suppress muting of a video signal in a period of switching video processing.

An example of processing performed by system 1 will be described using a specific example of a video signal.

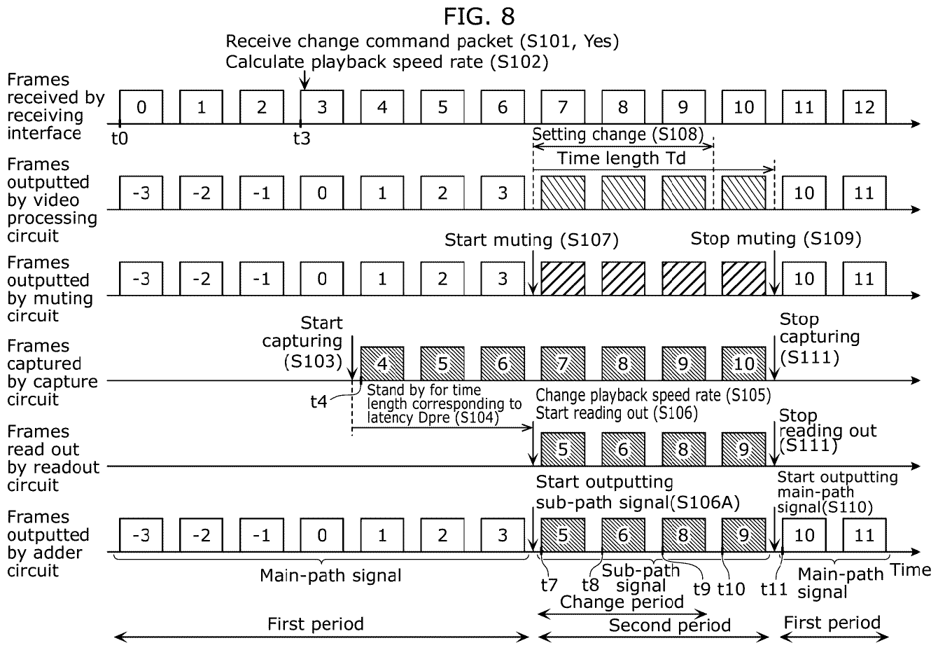

FIG. 8 is an explanatory diagram illustrating an example of processing performed by display device 10 according to the embodiment.

FIG. 8 illustrates an example of processing that is performed by display device 10 when performing setting change to change a state where video processing circuit 13 performs video processing in pattern 2 on a video signal to a state where video processing circuit 13 performs video processing in pattern 1 on the video signal. The processing illustrated in FIG. 8 is, for example, performed by display device 10 performing the set of processes shown in the flowchart illustrated in FIG. 7 using a pattern table (see FIG. 2) and a time table (see FIG. 3).

In FIG. 8, frames received by receiving interface 11, frames outputted by video processing circuit 13, frames outputted by muting circuit 14, frames captured by capture circuit 17, frames read out by readout circuit 19, and frames outputted by adder circuit 15 are illustrated in the stated order from above. In FIG. 8, the right direction indicates a direction in which time progresses.

Here, latency Dpre and latency Dpost are each represented in units of the number of frames. Namely, latency Dpre denotes latency D1 in pattern 1 and corresponds to three frames, specifically. Moreover, latency Dpost denotes latency D2 in pattern 2 and corresponds to one frame, specifically.

Furthermore, it is assumed that time length Tc required for the setting change is a time length corresponding to three frames (i.e., 3/frame rate). Time length Td is calculated as a time length corresponding to four frames, by using the above-described (Equation 1) as shown below.

Td=3+1=4

Moreover, playback speed rate P is calculated as 1.5, by using the above-described (Equation 2) as shown below.

P=1+(3−1)/4=1.5

Furthermore, a different one of sequential numbers ( . . . , −2, −1, 0, 1, 2, . . . ) is assigned to each frame of a video signal. The sequential numbers assigned to frames of a video signal are sequential numbers indicating the order of reproducing the frames or sequential numbers indicating the order of receiving the frames by receiving interface 11, and do not have other meanings.

At time to illustrated in FIG. 8, receiving interface 11 receives frame #0. Since latency Dpre corresponds to three frames, video processing circuit 13 outputs frame #−3 at time to. Muting circuit 14 obtains frame #−3 outputted by video processing circuit 13 and outputs frame #−3 obtained as it is without muting. A frame outputted by adder circuit 15 at time t0 is the same as the frame that is a main-path signal outputted by muting circuit 14, and is frame #−3. It should be noted that at time to, capture circuit 17 and readout circuit 19 output nothing since capture circuit 17 and readout circuit 19 are not operating.

When receiving interface 11 receives a change command packet at time t3 (Yes at step S101), capture circuit 17 starts capturing a received signal and storing the received signal in memory 18 at time t4 (step S103). Frames stored in memory 18 are frames #4, #5, and #6.

Then, after standing by for a time length corresponding to latency Dpre (step S104), display device 10 performs processing of switching the signal outputted by adder circuit 15 from the main-path signal to a sub-path signal at time t7.

Specifically, processor 12 sets a playback speed rate of the sub-path signal (step S105), readout circuit 19 starts, under the control of processor 12, reading out a frame from memory 18 and providing the frame to adder circuit 15 (step S106), and adder circuit 15 starts, under the control of processor 12, outputting the sub-path signal as a composite signal (step S106A). At this time, by processor 12 setting opacity r of the OSD signal of adder circuit 15 to 1, adder circuit 15 can output, as a composite signal, the frame of the sub-path signal. The frame outputted by adder circuit 15 is the sub-path signal provided from readout circuit 19 and is frame #5. Moreover, at time t7, muting circuit 14 starts muting under the control of processor 12 (step S107).

It should be noted that the fact that the frame outputted by adder circuit 15 is frame #5 is derived by using the above-described (Equation 3) as shown below.

Since the frame outputted by adder circuit 15 immediately before a second period is frame #3, F0=3 is satisfied in the above-described (Equation 3). Moreover, since the frame read out from memory 18 by readout circuit 19 at time t7 is the first frame in the second period, n=1 is satisfied. Accordingly, frame Fr(1) read out from memory 18 by readout circuit 19 at time t7 is calculated as frame #5, as shown below.

Fr(1)=3+Round(1.5×1)=5

Then, after muting circuit 14 starts muting under the control of processor 12, processor 12 instructs video processing circuit 13 to perform setting change (step S108). In time length Tc, video processing circuit 13 performs the setting change under the control of processor 12.

In a period from time t8 within the second period (time t7 to time t11), readout circuit 19 reads out frames #6, #8, and #9 from memory 18 in accordance with playback speed rate P and provides the frames to adder circuit 15, and adder circuit 15 outputs the frames.

It should be noted that the fact that the frames outputted by adder circuit 15 are frames #6, #8, and #9 is derived by using the above-described (Equation 3) as shown below.

In the above-described (Equation 3), the frames read out from memory 18 by readout circuit 19 at times t8, t9, and t10 are the second, third, fourth frames in the second period. Accordingly, frames Fr(2), Fr(3), and Fr(4) read out from memory 18 by readout circuit 19 at times t8, t9, and t10 are calculated as frames #6, #8, and #9 as shown below.
Fr(2)=3+ROUND(1.5×2)=6
Fr(3)=3+ROUND(1.5×3)=8
Fr(4)=3+ROUND(1.5×4)=9

Then, at time t10 when time length Tc required for the setting change has elapsed from when muting circuit 14 starts muting, processor 12 instructs video processing circuit 13 to start video processing after the setting change. Under the control of processor 12, video processing circuit 13 starts the video processing after the setting change on a frame (specifically frame #10) at time t10.

At time t11, display device 10 performs processing of switching the signal outputted from adder circuit 15 from the sub-path signal to the main-path signal.

Specifically, muting circuit 14 stops muting under the control of processor 12 (step S109), and adder circuit 15 starts outputting, as a composite signal, a frame of the main-path signal under the control of processor 12 (step S110). At this time, by processor 12 setting opacity r of the OSD signal of adder circuit 15 to 0, adder circuit 15 can output, as a composite signal, the frame of the main-path signal. Moreover, under the control of processor 12, readout circuit 19 stops reading out a frame (step S111).

From time t11, video processing circuit 13 outputs frames (frames #10 and #11) on which the video processing after the change has been performed. As described above, since video processing circuit 13 has started the video processing after the setting change at time t10 and Dpost=1 is satisfied, video processing circuit 13 completes the video processing of frame #10 and outputs frame #10 at time t11.

As described above, display device 10 can reproduce frames at playback speed rate P in the second period and, after the second period (i.e., from time t11), display device 10 can output a composite signal delayed by one frame relative to a received frame. Thus, since display device 10 can continue outputting a video signal even in a period of switching video processing, muting of a video signal can be suppressed.

### Variation 1 of Embodiment

In the present variation, a processing device or the like that suppresses muting of a video signal in a period of switching video processing will be described.

Although display device 10 (more specifically processing device 10A) changes video processing performed by video processing circuit 13 in accordance with a change command from transmission device 5 in the above-described embodiment, display device 10 can change processing performed by video processing circuit 13 even when there is no change command from transmission device 5.

For example, by using an operation menu provided by display device 10, display device 10 can change video processing performed by video processing circuit 13 in the same manner as the above-described embodiment even when a user provides instruction to change video processing. For example, the operation menu includes an option to turn on or off low-latency video processing. It is assumed that the user refers to the operation menu provided and performs, on display device 10, an operation to select whether to turn on or off low-latency video processing. Display device 10 can receive the above-described operation performed by the user and change the processing performed by video processing circuit 13 in accordance with the above-described operation. In this case, when the operation performed by the user is received by using a remote-control light receiver or a touch-panel detector at step S101 (see FIG. 7) instead of receiving a change command packet, processor 12 can perform the process at step S102 and subsequent steps.

Thus, even in a configuration includes only display device 10 (i.e., a configuration does not include transmission device 5), a change command in the present invention can be achieved by the user operating the operation menu.

Moreover, when the user provides instruction to change video processing by using the operation menu, a change command may be a command to change video processing on an RGB video signal, besides a command to change to low-latency video processing.

Generally, image quality enhancement means such as noise reduction, sharpness correction, or tone correction is video processing on a YUV video signal that is represented by using a color difference signal. However, there may be an instance where a capacity required for memory 18 is reduced by reducing U and V signal components that are color information. When receiving interface 11 receives an RGB video signal outputted by a personal computer or the like, there may be an instance where a mode in which image quality enhancement means such as noise reduction, sharpness correction, or tone correction is bypassed for preventing reduction of such color information is provided. When a user provides an instruction to change video processing on the RGB video signal by using the operation menu, the above-described image quality enhancement means is bypassed and therefore latency time of video processing circuit 13 is changed consequently.

In this case, since display device 10 suppresses muting of a video signal in a period of switching video processing, an RGB process may be added for each video processing type in FIG. 2 and FIG. 3. Specifically, new video processing patterns that indicate combinations of on/off states of video processing on an RGB video signal and on/off states of high image quality video processing are added to the pattern table shown in FIG. 2, and latency Dx is added to each of the new video processing patterns added. Moreover, time length T3 required for changing video processing performed on a video signal to video processing on an RGB video signal is added to the time table shown in FIG. 3.

Thus, a change command in the present invention includes a command to consequently change latency time of video processing circuit 13 and is not necessarily a change command to provide an instruction to perform low-latency video processing.

### Variation 2 of Embodiment

In the present variation, a processing device or the like that suppresses muting of a video signal in a period of switching video processing will be described. The processing device according to the present variation more appropriately suppresses muting of a video signal in a period of switching video processing, by using the fact that an adder circuit generates a composite signal by blending pixel values.

A configuration of display device 10 according to the present variation is the same as that of display device 10 according to the above-described embodiment.

However, display device 10 according to the present variation is different from display device 10 according to the above-described embodiment in that, at a time immediately before or after a second period, adder circuit 15 generates and outputs a composite signal by blending a pixel value included in a frame of a main-path signal with a pixel value of a frame included in a sub-path signal. It should be noted that, at both times immediately before and after a second period, adder circuit 15 may generate and output a composite signal by blending a pixel value included in a frame of a main-path signal with a pixel value included in a frame of a sub-path signal.

Specifically, adder circuit 15 can output N frames before a second period as a composite signal having a pixel value obtained by blending a pixel value included in N frames of a main-path signal with a pixel value included in N frames of a sub-path signal. N is, for example, an integer no less than 1 and no more than 30, but the present disclosure is not limited to this example. At this time, for N frames, opacity r of the sub-path signal may be a constant value (e.g., 50%). Moreover, for N frames, opacity r may be gradually changed from a relatively low value to a relatively high value. For example, when N is 3, the opacity of the first to third frames may be 25%, 50%, and 75%, respectively.

Moreover, adder circuit 15 can output M frames after the second period as a composite signal having a pixel value obtained by blending a pixel value included in M frames of the main-path signal with a pixel value included in M frames of the sub-path signal. M is, for example, an integer no less than 1 and no more than 30, but the present disclosure is not limited to this example. M may be the same as or different from N that is the number of frames before the second period. For M frames, opacity r of the sub-path signal may be a constant value (e.g., 50%). Moreover, for M frames, opacity r may be gradually changed from a relatively high value to a relatively low value. For example, when M is 3, the opacity of the first to third frames may be 75%, 50%, and 25%, respectively.

Moreover, processor 12 identifies number Fr(n) of an n-th (n≥1) frame in the sub-path signal read out from memory 18 by readout circuit 19 in the second period, by using (Equation 14) shown below. (Equation 14) is used instead of (Equation 3). In (Equation 14), N denotes the number of frames that are outputted by adder circuit 15 before the second period and are included in the composite signal having the pixel value obtained by blending the pixel value included in N frames of the main-path signal with the pixel value included in N frames of the sub-path signal. Other variables are the same as that in (Equation 3).

Fr(n)=F0+N+Round(P×n) (Equation 14)

Processing performed by display device 10 according to the present variation will be described. Here, an example in which the number of frames before the second period and the number of frames after the second period is the same N will be described. Moreover, an example in which opacity r for N frames is a constant value that is 50% will be described.

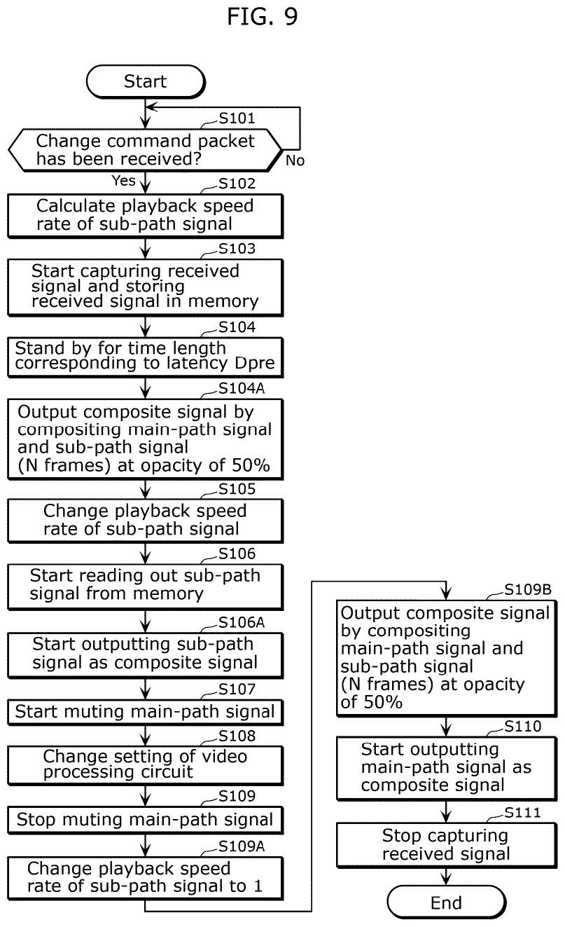

FIG. 9 is a flowchart showing processing performed by processor 12 when changing video processing according to the present variation. In FIG. 9, for processes that are the same as the processes performed by display device 10 according to the above-described embodiment (see FIG. 7), the same reference signs may be used and detailed explanations may be omitted.

When receiving interface 11 receives a change command packet transmitted by transmission device 5, processor 12 performs control to: calculate playback speed rate P of a sub-path signal; start capturing a received signal and storing the received signal in memory 18; and stand by for a time length corresponding to latency Dpre (steps S101 to S104).

At step S104A, processor 12 controls adder circuit 15 to output a composite signal by compositing a main-path signal and N frames of the sub-path signal at opacity of 50%.

Then, in the same manner as processor 12 according to the above-described embodiment, processor 12 performs control to start outputting the sub-path signal as a composite signal and change a setting of video processing circuit 13 (steps S105 to S109).

At step S109A, processor 12 changes playback speed rate P of the sub-path signal to 1 (i.e., 1×speed).

At step S109B, processor 12 controls adder circuit 15 to output a composite signal by compositing the main-path signal and N frames of the sub-path signal at opacity of 50%.

Then, in the same manner as processor 12 according to the above-described embodiment, processor 12 starts outputting the main-path signal as a composite signal and stops capturing by capture circuit 17 (steps S110 and S111).

By the set of processes illustrated in FIG. 9, display device 10 can suppress muting of a video signal in a period of switching video processing.

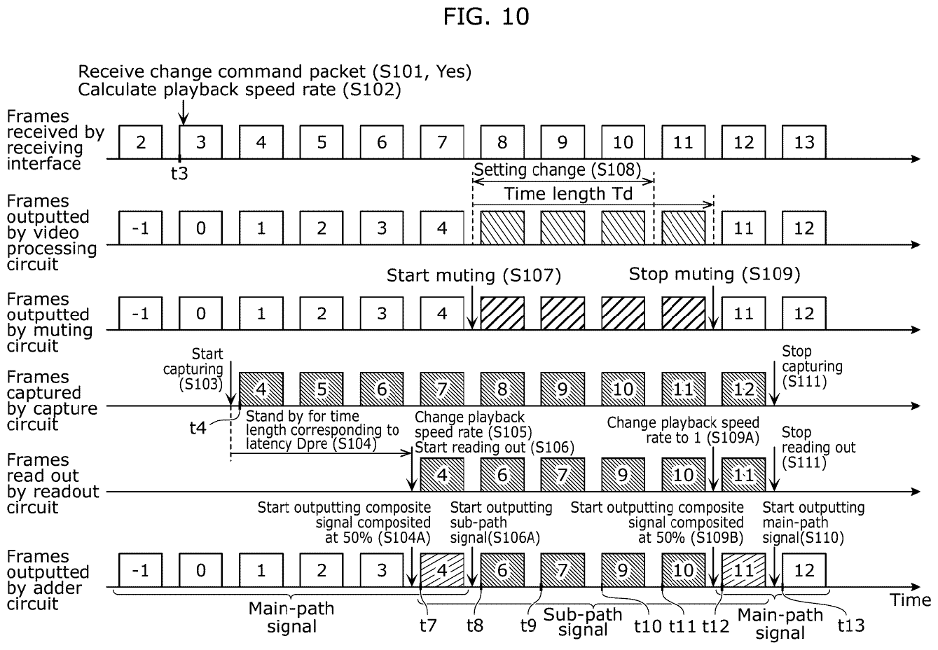

FIG. 10 is an explanatory diagram illustrating an example of processing performed by display device 10 according to a variation of the present embodiment.

Similar to FIG. 8, FIG. 10 illustrates an example of processing that is performed by display device 10 when performing setting change to change a state where video processing circuit 13 performs video processing in pattern 2 on a video signal to a state where video processing circuit 13 performs video processing in pattern 1 on the video signal.

In FIG. 10, a frame display mode, latency Dpre, latency Dpost, time length Tc, time length Td, playback speed rate P, etc. are the same as those in FIG. 8. Moreover, N that is the number of frames that are outputted as a composite signal is assumed to be 1, and the composite signal has a pixel value obtained by blending a pixel value included in a frame of a main-path signal with a pixel value included in a frame of a sub-path signal.

When receiving interface 11 receives a change command packet at time t3 (Yes at step S101), capture circuit 17 starts capturing a received signal and storing the received signal in memory 18 at time t4 under the control of processor 12 (step S103). Frames stored in memory 18 are frames #4, #5, and #6.

Then, after standing by for a time length corresponding to latency Dpre (step S104), adder circuit 15 outputs, under the control of processor 12, a composite signal (frame #4) by compositing a main-path signal and one frame of a sub-path signal from time t7 (step S104A).

Then, under the control of processor 12, readout circuit 19 starts reading out a frame from memory 18 and provides the frame to adder circuit 15. The frame outputted by adder circuit 15 is frame #6 (i.e., the sub-path signal) provided from readout circuit 19.

Then, after muting circuit 14 starts muting (step S107), video processing circuit 13 performs setting change under the control of processor 12 (step S108). Time length Tc (i.e., time length corresponding to three frames) is required for the setting change.

In a second period (time t8 to time t12), readout circuit 19 reads out frames #6, #7, #9, and #10 from memory 18 in accordance with playback speed rate P and provides the frames to adder circuit 15, and adder circuit 15 outputs the frames.

It should be noted that the fact that the frames outputted by adder circuit 15 are frames #6, #7, #9, and #10 is derived by using the above-described (Equation 14) as shown below.

In the above-described (Equation 14), the frames read out from memory 18 by readout circuit 19 at times t8, t9, t10, and t11 are the first, second, third, and fourth frames in the second period. Moreover, N=1 is satisfied. Accordingly, frames Fr(1), Fr(2), Fr(3), and Fr(4) read out from memory 18 by readout circuit 19 at times t8, t9, t10 and t11 are calculated as frames #6, #7, #9, and #10 as shown below.
Fr(1)=3+1+ROUND(1.5×1)=6
Fr(2)=3+1+ROUND(1.5×2)=7
Fr(3)=3+1+ROUND(1.5×3)=9
Fr(4)=3+1+ROUND(1.5×4)=10

Then, adder circuit 15 outputs, under the control of processor 12, a composite signal (frame #11) by compositing the main-path signal and one frame of the sub-path signal from time t12 (step S109B). Then, from time t13, video processing circuit 13 performs video processing after the change on a received frame, and adder circuit 15 outputs the frame (frame #12) on which the video processing has been performed.

Moreover, at time t12, muting circuit 14 stops muting under the control of processor 12 (step S109). Furthermore, at time t13, capture circuit 17 stops capturing under the control of processor 12 and readout circuit 19 stops reading out under the control of processor 12 (step S111).

As described above, display device 10 can reproduce frames at playback speed rate P in the second period and, after the second period (i.e., from time t12), display device 10 can output a composite signal delayed by one frame relative to a received frame. Moreover, since a frame having a pixel value obtained by blending a pixel value included in a frame of the main-path signal with a pixel value included in a frame of the sub-path signal is outputted as a composite signal at times before and after the second period, it is possible to suppress a rapid change in image quality in switching a composite signal even when a video signal format is different between the main-path signal and the sub-path signal (e.g., when resolution decreases in capturing).

Thus, display device 10 can suppress muting of a video signal in a period of switching video processing.

As described above, the embodiment and variations thereof have been described as examples of the techniques disclosed in the present disclosure. To that end, the appended figures and the detailed description have been provided.

Accordingly, in order to exemplify the above implementation, constituent elements in the appended figures and the detailed description include not only a constituent element that is necessary for solving the problem but also a constituent element that is unnecessary for solving the problem. Therefore, such an unnecessary constituent element should not be deemed essential due to the mere fact that they are described in the appended drawings and the detailed description.

Moreover, since the above-described embodiment is for illustrating techniques according to the present disclosure, various modifications, substitutions, additions, and omissions are possible in the scope of the appended claims and equivalents thereof.

### INDUSTRIAL APPLICABILITY

The present disclosure is applicable as a video signal processing device that performs, on a video signal, video processing in a pattern selected from a plurality of video processing patterns and outputs the video signal.

### REFERENCE SIGNS LIST

5 transmission device
10 display device
10A processing device
11 receiving interface
12 processor
13 video processing circuit
14 muting circuit
14A compositing circuit
15 adder circuit
16 display
17 capture circuit
18, 20 memory
19 readout circuit
21 audio processing circuit
22 loudspeaker

1. A video signal processing device comprising:
a receiving interface that receives a video signal that represents a moving image;
a video processing circuit that generates a first signal by performing video processing in a pattern among a plurality of video processing patterns in which the video processing circuit is capable of performing video processing on the video signal received by the receiving interface;
a capture circuit that generates a second signal by capturing the video signal received by the receiving interface;
a compositing circuit that outputs a composite signal by compositing the first signal and the second signal; and
a processor that:
(a) in a first period, controls the compositing circuit to output the first signal as the composite signal;
(b) in a second period, controls the video processing circuit to perform changing of the pattern of the video processing performed by the video processing circuit, the second period being a period not included in the first period; and
(c) in a change period, controls: the capture circuit to generate the second signal; and the compositing circuit to output the second signal as the composite signal, the change period being a period in which the changing is performed.

2. The video signal processing device according to claim 1 further comprising:
a memory, wherein
the processor controls the capture circuit to store, in the memory, the second signal generated by the capture circuit, and
when a first time length corresponding to first latency that occurs in the video signal due to the video processing in a first pattern is different from a second time length corresponding to second latency that occurs in the video signal due to the video processing in a second pattern, the processor controls the compositing circuit to output, in the change period, the second signal whose elapsed time since being stored in the memory is a time length between the first time length and the second time length, the first pattern being a pattern before the changing among the plurality of video processing patterns, the second pattern being a pattern after the changing among the plurality of video processing patterns.

3. The video signal processing device according to claim 2, wherein
the processor controls the compositing circuit to cause the elapsed time of the second signal since being stored in the memory to change from the first time length toward the second time length, the second signal being outputted by the compositing circuit in the change period.

4. The video signal processing device according to claim 1, wherein
the receiving interface receives a command to change the video processing performed on the video signal by the video processing circuit to lower-latency video processing, and
when the receiving interface receives the command, in (b), the processor controls the video processing circuit to change the video processing performed on the video signal to the lower-latency video processing.

5. The video signal processing device according to claim 1, wherein
at a time immediately before or after the change period, the processor controls the compositing circuit to generate and output the composite signal by blending a pixel value included in the first signal with a pixel value included in the second signal.

6. The video signal processing device according to claim 1, wherein
the compositing circuit includes an on-screen display (OSD) compositing circuit that composites the first signal and the second signal as an OSD signal.

7. The video signal processing device according to claim 1, wherein
the compositing circuit further includes a muting circuit that switches whether to mute the first signal generated by the video processing circuit, and
the processor controls the muting circuit to mute the first signal in the change period.

8. A video signal processing method that is performed by a video signal processing device that includes:
a receiving interface that receives a video signal that represents a moving image;
a video processing circuit that generates a first signal by performing video processing in a pattern among a plurality of video processing patterns in which the video processing circuit is capable of performing video processing on the video signal received by the receiving interface;
a capture circuit that generates a second signal by capturing the video signal received by the receiving interface;
a compositing circuit that outputs a composite signal by compositing the first signal and the second signal; and
a processor,
the video signal processing method comprising the following executed by the processor:
(a) in a first period, controlling the compositing circuit to output the first signal as the composite signal;
(b) in a second period, controlling the video processing circuit to perform changing of the pattern of the video processing performed by the video processing circuit, the second period being a period not included in the first period; and
(c) in a change period, controlling: the capture circuit to generate the second signal; and the compositing circuit to output the second signal as the composite signal, the change period being a period in which the changing is performed.

2. A non-transitory computer-readable recording medium having recorded thereon a program for causing a computer to execute the video signal processing method according to claim 8.
